(19) United States
(12) Patent Application Publication
(10) Pub. No.: US 2007/0073765 A1
(43) Pub. Date: Mar. 29, 2007

(54) Metadata-based schema generator

(75) Inventor: Hui-Min Chen, San Leandro, CA (US)

Correspondence Address: HUI-MIN CHEN, 15681 ANCHORAGE DRIVE, SAN LEANDRO, CA, 94579, US

(73) Assignee: Epiphany, Inc., San Mateo, CA (US)

(21) Appl. No.: 11/234,456

(22) Filed: Sep. 23, 2005

(51) Int. Cl. G06F 7/00

(52) U.S. Cl. 707/103 R

(57) ABSTRACT

A database schema generator that extracts schema information from the metadata of a database schema editing tool and creates java objects that when run against a target database will restore the database schema including tables, views, indexes, stored procedures, and triggers.

### BACKGROUND

1. Field of the Invention

The present invention relates to relational databases systems and more particularly to database schema.

2. Description of the Related Art

A database schema is stored in a database editing tool. Conventional database editing tools have the capacity to export the database schema into a particular vender database. However, this approach has drawbacks. Each time it is desired to access the particular vender's database, the accessing entity must connect to the database editing tool to locate the database schema prior to communicating with the database. Connecting to the database editing tool can be cumbersome. A better method of accessing database schema is needed.

### BRIEF DESCRIPTION OF THE DRAWINGS

It is to be understood that, in the drawings, like reference numerals designate like structural elements. Also, it is understood that the depictions in the Figures are not necessarily to scale.

FIG. 1A is an exemplary representation of a system exporting a database schema to a target database;

FIG. 1B is an exemplary representation of a system restoring a database schema to a target database;

FIG. 2 is an exemplary representation of a flow chart for restoring a database schema to a target database using java objects;

FIG. 3 is an exemplary representation of a flow chart for creating java objects to be used to restore a database schema; and

FIG. 4 is an exemplary representation of a java object used for database schema generation.

FIG. 5 is an exemplary portion of an initialization script generated by the database schema generator.

### DETAILED DESCRIPTION

In the following description, numerous specific details are set forth to provide a thorough understanding of the embodiments. It will be apparent, however, to one skilled in the art that the embodiments may be practiced without some or all of these specific details. In other instances, well known process steps have not been explained in detail in order to avoid unnecessarily obscuring the description.

A database includes a collection of tables that contain data and other objects such as views, indexes, stored procedures, and triggers. The data is concentrated around a particular subject such as product inventory information. The objects define the actions that can be performed on the data.

Some databases can be very complex and require software to help record and model the database design. The database design details all tables, columns, keys, data types, and relationships in the database. Database design editing tools may graphically illustrate the database design to make editing more user-friendly. The stored database design may be referred to as a database schema. Database design editing tools can be referred to as database schema editing tools, or as entity-relationship editing tools.

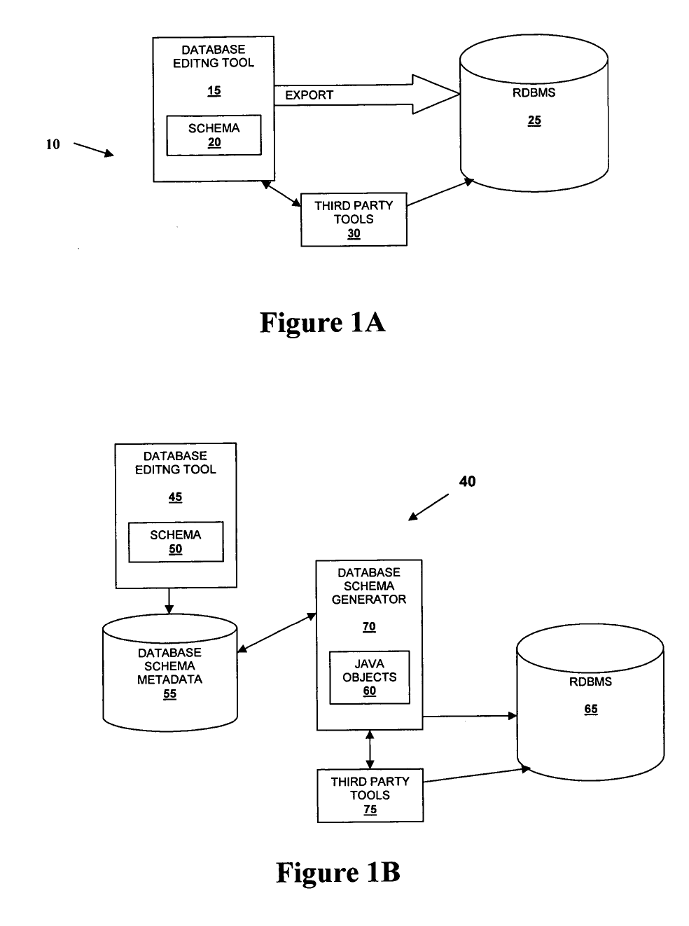

The system 10 in FIG. 1A shows an exemplary representation of database schema generation. Database editing tool 15 is a component in the system. The schema 20 is normally stored within the confines of the database design editing tool 15. The database editing tool 15 can export the schema 20 to a target database 25 to create the database environment configured in, and represented by, the database schema.

The database schema is also used by any entity attempting to communicate with the database, such as third party database tool 30 shown in FIG. 1A. To learn how to navigate the database, a third party tool accesses the database schema including the tables, objects, and relationships, to become informed on database organization. An example of a third party tool 30, is software that connects the database schema editing tool to other software. That is, software that converts the entity relationship format of the database schema to another format such as object oriented format. However, the database schema is stored within the database design editing tool, and accessing a database design editing tool usually requires a great deal of computing time and resources. A better method of gaining access to the schema of a database is required.

A java-based database schema generator system 40 is shown in FIG. 1B. Database editing tool 45 holds database schema 50. The database editing tool also stores database schema metadata 55 in a metadata database. Database schema generator 70 includes java objects 60. The database schema generator accesses database schema metadata 55 one time to create the java objects modeled after the schema metadata using a relation-to-object mapping technique, then does not access the schema metadata 55 again unless it has been edited. The database generator 70 uses the created java objects to restore the database environment to target database 65. In some embodiments the java objects may be modified for customization. Note that the Database schema generator 70 can communicate with any database schema editor that uses entity-relationship formatting.

Once created, the java objects may be used by third party database tools 75 to access the target database. Database schema generator 70 can serve as a database schema hub which interacts with any schema editing tool and performs database schema fusion. That is, the database schema generator 70 can serve as an interface between any entity-relationship, or database schema editing tool, and any tool that can take advantage of java object technology. In some embodiments, the third party tools may access the java objects via an Application Programming Interface (API). Third party tools may include schedulers, presentation tools, and business intelligence software. These software packages take advantage of, and build upon, Java objects. For instance business intelligence software allows end users to build queries from Java objects without writing SQL code or connecting to a database. These queries manipulate the Java objects, and render business intelligence reports, charts, metrics, etc.

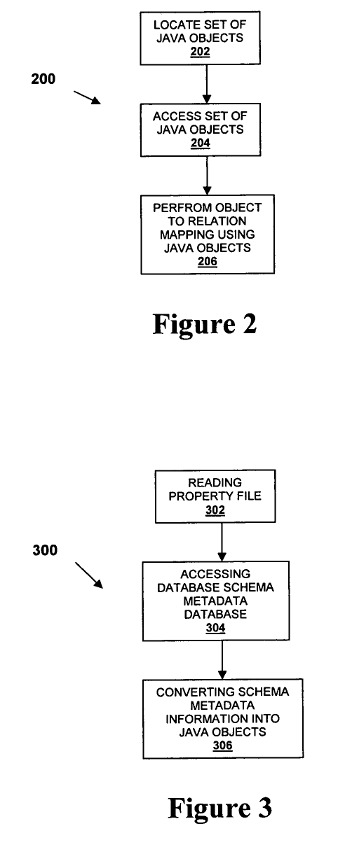

FIG. 2 is an exemplary representation of a flow chart 200 for restoring a database schema to a target database using java objects. In process action 202 the set of java objects are located. The java objects are accessed in process action 204. In process action 206, object to relation mapping is performed by the java-based database schema generator system using the java objects to restore the database schema in the target database. In some embodiments, the database schema is restored directly in the database. In some embodiments, the java-based schema generator creates database schema scripts, called initialization scripts, which are used to restore the database schema to the target database.

FIG. 3 is an exemplary representation of a flow chart 300 for locating java objects to be used to restore a database schema. In process action 302, the property file is read. The property file reveals where the database information files are located, including the database schema metadata database. The database schema metadata database is accessed in process action 304. In process action 306, relation to object mapping is performed to convert the schema metadata database into java objects.

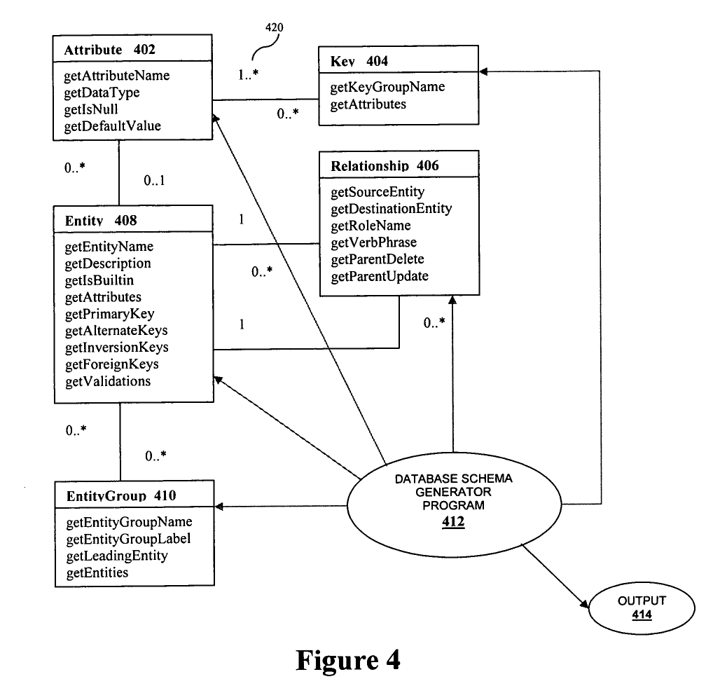

The java objects are based on a java object view model. The view model details the structure of the java object. An exemplary representation of a java object is represented in FIG. 4. The rectangular shapes 402-410 represent java objects and contain the name of the java object. The object actions are displayed below the name of each java object. The lines between java objects represent their relationship or interaction. The numbers along the lines between the java objects, such as that of element 420, show cardinality.

Cardinality defines the relationship between related entities or objects in terms of numbers. For example, an entity group object may contain none, or may contain many entity objects per object in another entity. For example, an employee table may have only one employee name for an individual, but the phone number table may have many phone numbers stored for that individual. The three main cardinality relationships are one-to-one, one-to-many, and many-to-many.

Oval 414 represents the database schema output of the database schema generator program 412. In some embodiments, the output is database schema. In some embodiments, the output is an initialization script that is configured to restore the database schema.

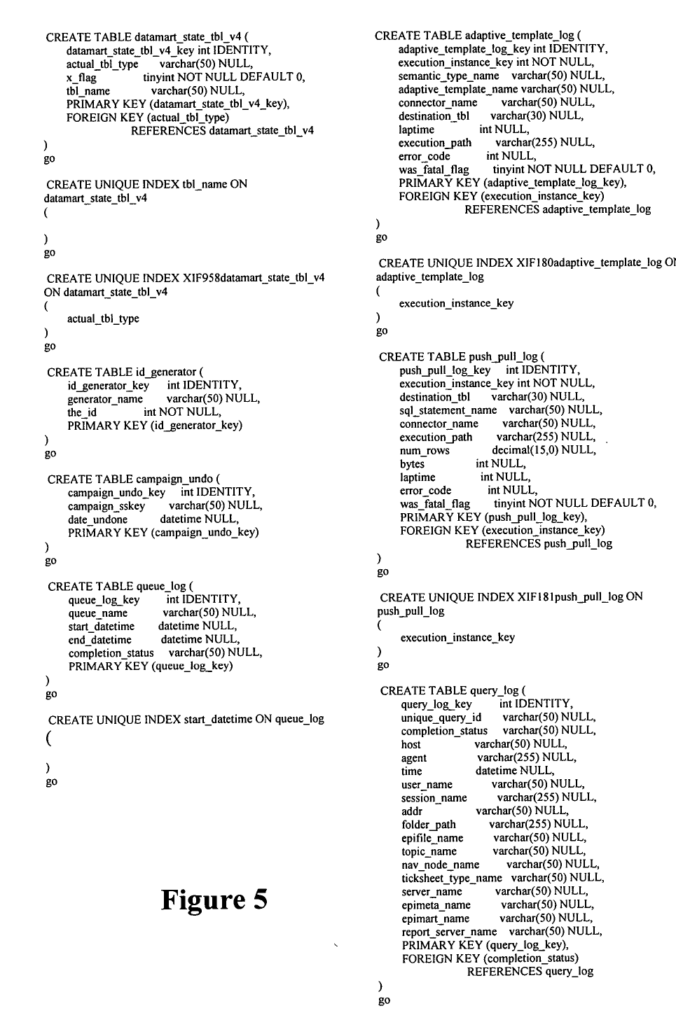

FIG. 5 shows a portion of an initialization script created by database schema generator 414. Although, this particular script is configured to restore a database schema in a Microsoft SQLServer database environment, the schema generator can support other types of database environments as well.

What is claimed is:

1. A method of creating a database schema for a target database using java objects, the method comprising:
locating a set of java objects, the java objects correlating to the database;
accessing the set of java objects; and
restoring the database schema for the target database based on the set of java objects.

2. The method of claim 1, wherein locating the set of java objects comprises:
extracting schema information from a database schema editing tool; and
converting the schema information into one or more java objects.

3. The method of claim 2, wherein extracting database schema information comprises:
reading a property file to locate the database schema editing tool metadata database; and
accessing the database schema editing tool metadata database.

4. The method of claim 2, wherein converting comprises performing relation-to-object mapping.

5. The method of claim 1, wherein restoring the database schema comprises performing object-to-relation mapping.

6. The method of claim 1, wherein restoring the database schema comprises directly creating the schema in the target database.

7. The method of claim 1, wherein restoring the database schema comprises generating database scripts that are configured to restore the database schema.

8. The method of claim 1, wherein restoring the database schema comprises creating a plurality of database objects.

9. The method of claim 1, wherein an external database tool accesses the database schema without accessing a database schema editing tool.

10. The method of claim 9, wherein the external database tool accesses the database schema using the set of java objects.

11. The method of claim 9, wherein the database tool is business intelligence software.

12. A computer program product stored on computer readable medium, the program when executed by a processor performs a method of creating a database schema for a database using java objects, the method comprising:
locating a set of java objects, the Java objects correlating to the database;
accessing the set of java objects; and
restoring the database schema based on the of java objects.

13. The computer program product of claim 12, wherein locating the set of java objects comprises:
extracting schema information from a database schema editing tool; and
converting the schema information into one or more java objects.

14. The computer program product of claim 13, wherein extracting database schema information comprises:
reading a property file to locate the database schema editing tool metadata database; and
accessing the database schema editing tool metadata database.

15. The computer program product of claim 13, wherein converting the database schema comprises:
performing object-to-relation mapping.

16. The computer program product of claim 12, wherein restoring the database schema comprises directly creating the schema in the target database.

17. The computer program product of claim 12, wherein restoring the database schema comprises generating database scripts that are configured to restore the database schema.

18. The computer program product of claim 12, wherein restoring the database schema comprises creating a plurality of database objects.

19. The computer program product of claim 12, wherein an external database tool accesses the database schema without accessing a database editing tool.

20. The computer program product of claim 19, wherein the external database tool accesses the database schema using the set of java objects.

21. The computer program product of claim 19, wherein the database tool is business intelligence software.

22. A system for restoring a database schema, the system comprising:
a database schema metadata;
a database schema generator, the database schema generator being an entity separate from a database schema editing tool;
a set of java objects; and
a target database.

23. The system of claim 22, wherein the database schema metadata was created by the database schema editing tool.

24. The system of claim 22, wherein the set of java objects is created based on the database schema metadata.

25. The system of claim 22, wherein the database schema generator is configured to restore the database schema to the target database using the java objects.

26. The system of claim 22, wherein the database schema generator creates a database object.

27. The system of claim 22, further comprising a database tool, the tool configured to access the database schema without accessing the database editing tool.

28. The system of claim 27, wherein the database tool accesses the database schema using the java objects.

29. The system of claim 27, wherein the database tool is business intelligence software.
